(19) United States
(12) Patent Application Publication
(10) Pub. No.: US 2007/0032323 A1
(43) Pub. Date: Feb. 8, 2007

(54) Plastic hydraulic tensioner

(75) Inventor: Osamu Yoshida, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/446,285

(22) Filed: Jun. 2, 2006

(30) Foreign Application Priority Data
Aug. 3, 2005 (JP) 2005-226023

(51) Int. Cl. F16H 7/08; F16H 7/22

(52) U.S. Cl. 474/110; 474/109

(57) ABSTRACT

A plastic hydraulic tensioner comprises a metal liner insert-molded in a hole in a synthetic resin tensioner body. A protruding plunger, slidable in the liner of the tensioner body is urged in the protruding direction by a compression spring, and the plunger, the liner and the bottom of the lined hole form a high pressure oil chamber. A flat or concave groove is formed on or in the outer peripheral surface of the liner, and the liner is formed with a protrusion extending outward from the flat or groove to engage a part of the synthetic resin of the tensioner body so that the liner is prevented from being pushed out of the tensioner body by oil pressure in the high pressure oil chamber.

### CROSS-REFERENCE TO RELATED APPLICATION

This application claims priority on the basis of Japanese patent application 2005-226023, filed Aug. 3, 2005. The disclosure of Japanese application 2005-226023 is hereby incorporated by reference.

### FIELD OF THE INVENTION

This invention relates to hydraulic tensioners of the kind used to maintain proper tension in the timing chain of an automobile engine. More specifically, the invention relates to improvements in a hydraulic tensioner in which a plunger slides in, and protrudes from, a metal liner, insert-molded into a plastic tensioner body.

### BACKGROUND OF THE INVENTION

In most hydraulic tensioners currently in use, a ferrous metal plunger is arranged to protrude slidably from a die-cast tensioner body composed of a metal such as cast iron, aluminum alloy or the like. A metal tensioner body typically has a large mass. Reduction of the over all weight of the tensioner can be achieved by utilizing a tensioner body composed of a synthetic resin. A tensioner in which the tensioner body is composed of a synthetic resin is generally known as a “plastic tensioner.” In these plastic tensioners, the plunger slides in, and protrudes from, a metal liner provided in a plunger-receiving hole in the plastic tensioner body. Examples of plastic tensioners are described in U.S. patent application publication 2002/0142871, published Oct. 3, 2002, and U.S. Pat. No. 5,967,921, granted Oct. 19, 1999.

In the tensioner described in U.S. patent application publication 2002/0142871, the metal liner has a complicated shape and is difficult to manufacture. In the tensioner described in U.S. Pat. No. 5,967,921, a check ball retainer and a ring-shaped bottom plate are formed as integral parts of the liner. Thus, the structure of this tensioner is also complicated, and its manufacture is difficult.

To simplify the structure of a plastic tensioner and to make its manufacture easier, the structure shown in FIG. 15 has been used. In the tensioner 31, shown in FIG. 15, a cylindrical metal liner 33 is insert-molded into a synthetic resin tensioner body 32. A plunger 34 is slidable in the cylindrical metal liner 33. The plunger 34 has closed protruding end, an open rear end, and a hollow interior 35. The hollow interior 35 of the plunger accommodates a coiled compression spring 36, which biases the plunger 34 in the protruding direction so that it can apply tension to a traveling transmission chain, such as the timing chain of an internal combustion engine. A high pressure oil chamber 38 is formed by the hollow portion 35 of the plunger, the part of the cylindrical liner extending beyond the open end of the plunger, and the bottom portion 37 of the plunger-accommodating hole of the tensioner body 32, located beyond the cylindrical liner. A check valve 39 is provided in the bottom portion 37. The check valve permits oil to flow into the high pressure oil chamber 38 but blocks reverse flow of oil. The check valve 39 comprises a ball guide 40, a retainer 45, which supports the compression spring 36, a ball seat 41 and a ball 42, which closes a hole in the ball seat 41 through which oil can flow into the high pressure oil chamber from an oil reservoir (not shown) through passages 43 and 44.

In operation of the tensioner of FIG. 15, the high pressure oil chamber 38 is always filled with oil supplied through the check valve 39. When a traveling chain loosens, the plunger 34 is urged in the protruding direction by the biasing force exerted by the compression spring 36. As the plunger moves in the protruding direction, the check valve 39 opens, allowing oil to flow into the high pressure oil chamber 38. When tension is reestablished in the traveling chain, the plunger 34 is pushed into the cylinder 33 by the chain. The movement of the plunger into the cylinder causes the oil pressure in the high pressure oil chamber 38 to increase. The check valve 39 then closes, so that further retracting movement of the plunger 34 is blocked.

In the operation of the conventional plastic hydraulic tensioner of FIG. 15, the influence of the coil spring 36 can causes the plunger 34 to rotate. Because the outer peripheral surface of the cylindrical liner 33 is in the form of a circular cylinder, when the plunger rotates, the metal liner 33 can rotate with the plunger. Accordingly, wear between the liner and the tensioner body eventually produces a clearance through which excessive leakage of oil can take place. When excessive oil leakage takes place, the tensioner is no longer capable of exerting a sufficient holding force on the chain, and abnormal backlash noise is generated in the chain.

Furthermore, as shown in FIG. 16, since the metal liner is insert-molded into the tensioner body, there is a small clearance between the rear end of the metal liner 33 and the tensioner body, into which oil can enter. When chain tension increases, an impact force can push the plunger 34 into the cylindrical liner 33, causing a further increase in the oil pressure in the high pressure oil chamber 38. This further increase in oil pressure can resulting in a force (represented by the arrows in FIG. 16) pushing the liner 33 outward from the plunger-receiving hole in the tensioner body.

This invention addresses the above-described problems. The invention prevents rotation of the liner in the tensioner body as a result of rotation of the plunger, and thereby avoids the generation of an increased clearance between the tensioner body and the metal liner and resultant failure of the tensioner due to excessive oil leakage. The invention also prevents the metal liner from being pushed outward from the tensioner body as a result of excessive pressure in the high pressure oil chamber.

### SUMMARY OF THE INVENTION

The hydraulic tensioner according to the invention comprises a tensioner body composed of synthetic resin and having a hollow part formed therein for receiving a hollow cylindrical liner. The hollow part has an opening at one end and a bottom at its opposite end. The tensioner has a hollow metal liner insert-molded in the hollow part of the tensioner body. The liner has an outer peripheral surface, a cylindrical inner wall symmetrical about an axis, an inner end and an outer end, the inner end being closer than the outer end to the bottom of the hollow part of the tensioner body. A hollow plunger is slidable in the liner. The plunger has an open rear end, and a closed front end protrudable from the liner in a protruding direction. The hollow part of the plunger, the liner, and the bottom of the hollow part of the tensioner body, form a high pressure oil chamber. A compression spring, located in the high pressure oil chamber, and in compression between the closed front end of the hollow plunger and the bottom of the hollow part of the tensioner body, urges the hollow plunger in the protruding direction. The hollow metal liner has at least one flat surface or concave groove formed in its outer peripheral surface and disposed in parallel relationship to the axis of the cylindrical inner wall of the liner. A protrusion is formed on the flat surface or in the concave groove, the protrusion being engageable with a part of a wall of the hollow part of the tensioner body disposed between the protrusion and the opening of the hollow part of the tensioner body, to limit movement of the metal liner in a direction from the bottom of the hollow part toward the opening.

Preferably, apart of the wall of the hollow part engages the flat surface or the concave groove and prevents the liner from rotating, about the axis of the cylindrical inner wall of the liner, relative to the tensioner body. The protrusion is preferably disposed adjacent the inner end of the hollow metal liner.

In the tensioner according to the invention, even if the plunger is rotated by the influence of the compression spring, the metal liner will not rotate. Consequently, wear between the tensioner body and the liner is prevented, and excessive oil leakage from high pressure oil chamber, which can result in the generation of abnormal backlash noise in a transmission chain, can be prevented.

Furthermore, the engagement of the protrusion on the liner with the material of the tensioner body prevents the liner from being pushed out of the tensioner body by excessive oil pressure in the high pressure oil chamber of the tensioner.

Another advantage of the invention is that the protrusion can be formed easily in the process of machining or cutting a groove or flat surface in the lining, simply by machining or cutting the groove or flat surface along only a part of the axial length of the liner.

### BRIEF DESCRIPTION OF THE DRAWINGS

FIG. 1 is a cross-sectional view of a plastic hydraulic tensioner according to the invention;

FIG. 2 is an enlarged view of a portion of the tensioner of FIG. 1;

FIG. 3 is a front elevational view of the tensioner of FIG. 1;

FIG. 4 is a rear elevational view of the tensioner of FIG. 1;

FIG. 5 is a front side perspective view of the tensioner of FIG. 1;

FIG. 6 is a rear side perspective view of the tensioner of FIG. 1;

FIG. 7 is a cross-sectional view of a metal liner in accordance with a first embodiment of the invention;

FIG. 8 is a top plan view of the liner of FIG. 7;

FIG. 9 is a perspective view of the liner of FIG. 7;

FIG. 10 is a cross-sectional view of a metal liner in accordance with a second embodiment of the invention;

FIG. 11 is a top plan view of the liner of FIG. 10;

FIG. 12 is a perspective view of the liner of FIG. 10;

FIG. 13 is a cross-sectional view of a cylindrical liner in accordance with a third embodiment of the invention;

FIG. 14 is a top plan view of the liner of FIG. 13;

FIG. 15 is a cross-sectional view of a conventional plastic hydraulic tensioner; and

FIG. 16 is an enlarged view of a portion in the conventional tensioner shown in FIG. 15.

### DETAILED DESCRIPTION OF THE PREFERRED EMBODIMENTS

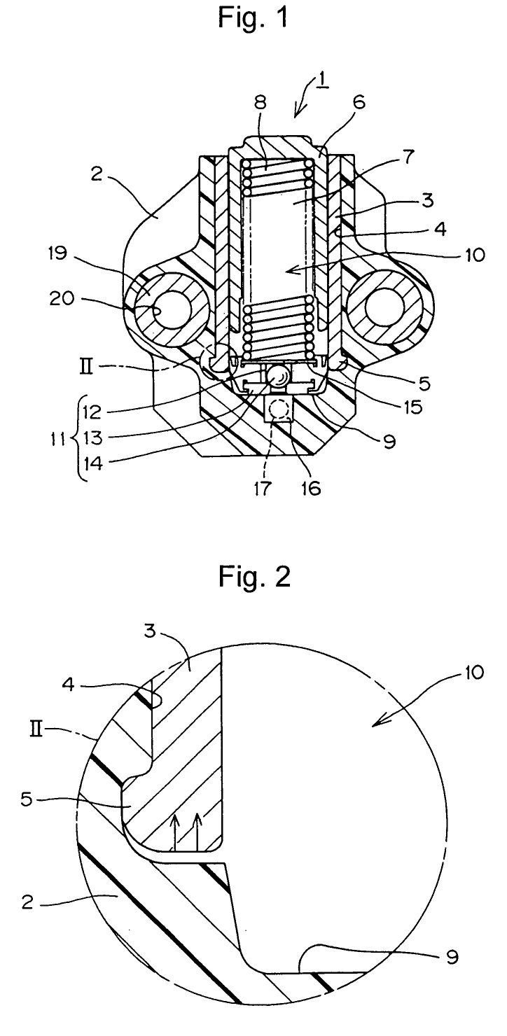

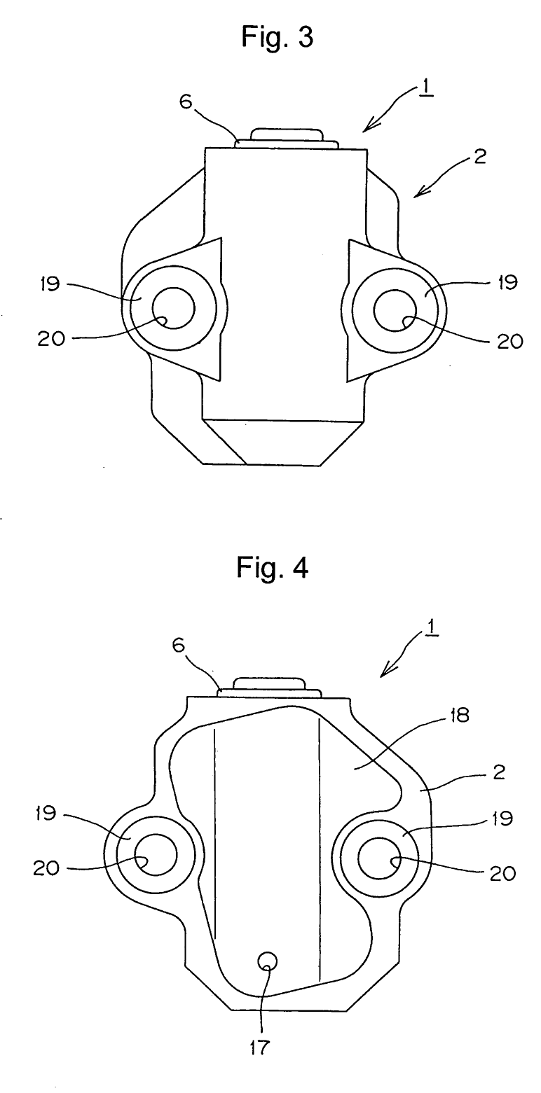

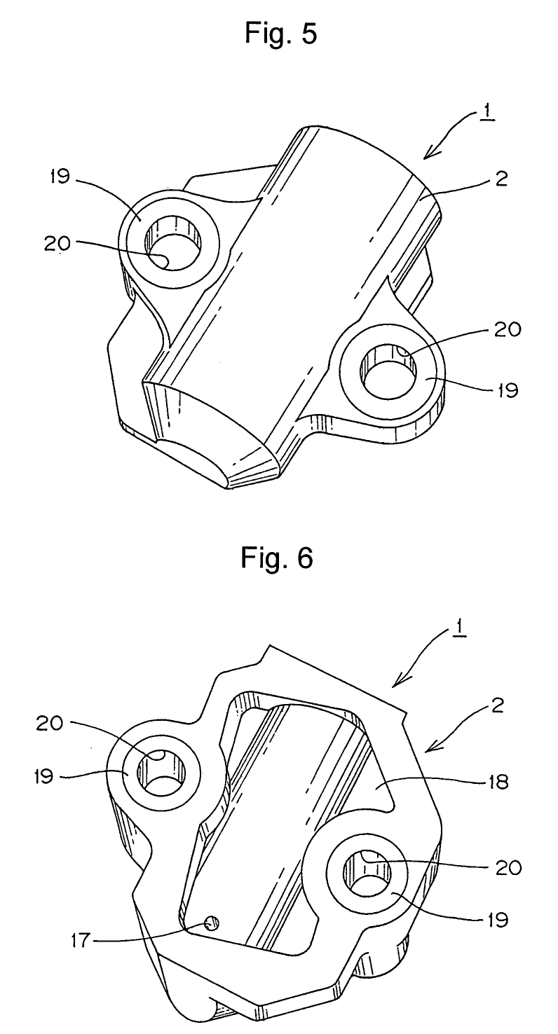

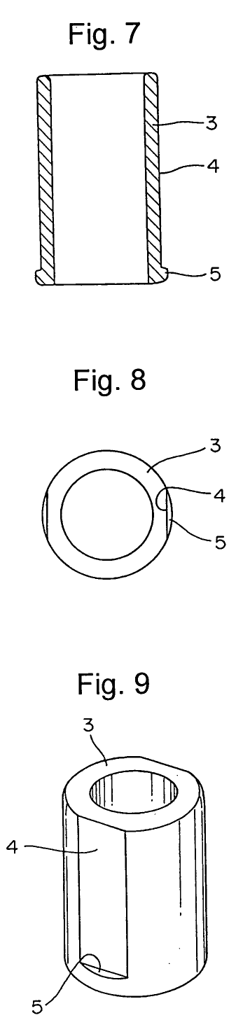

A first embodiment of the invention will be described with reference to FIGS. 1 to 9. As shown in FIG. 1, in a plastic hydraulic tensioner 1, a hollow metal liner 3, having a circular, cylindrical inner wall, is provided within a synthetic resin tensioner body 2 by insert molding. In the liner 3, as shown in FIGS. 7 and 8, two flat surfaces 4, both parallel to the axis of the cylindrical inner wall of the liner, are formed on the outer circumferential surface of the liner by cutting or machining. The machining or cutting steps by which the flat surfaces are formed are carried out only along a part of the axial length of the liner 3, so that, at one end of the liner, a pair of protrusions 5 are formed. As shown in FIG. 9, the protrusions 5 are preferably formed on the flat surfaces at one end of the liner 3, namely, the end that is nearest the bottom of the plunger-receiving hole in the assembled tensioner. However, it is possible to form the protrusions at intermediate positions along the length of the liner 3.

As shown in FIG. 1, a plunger 6 is slidable in the metal liner 3, and a closed end of the plunger protrudes from the liner. This end of the plunger is adapted to cooperate with a tensioner lever or similar device having a shoe on which a traveling chain can slide. The plunger 6 has a hollow interior 7, and an open rear end. The hollow interior 7 accommodates a coil-shaped compression spring 8, which biases the plunger 6 in the protruding direction to apply proper tension to a traveling chain (not shown).

A high pressure oil chamber 10 is formed by the hollow interior 7 of the plunger, the metal liner 3, and a bottom portion of the tensioner body 2 beyond the metal liner 3 (below the liner 3 in FIG. 1). A check valve 11 is provided at the bottom portion 9 of the high pressure oil chamber 10. The check valve permits flow of oil into the high pressure oil chamber 10, but blocks reverse flow of the oil. The check valve 11 comprises a ball guide 12, a retainer, which supports the compression spring 8, a ball seat 13, a check ball 14, which closes a through hole formed in the ball seat 13 for the inflow of oil. Oil inflow passages 16 and 17 conduct oil to the check valve from a reservoir 18 (FIGS. 4 and 6. The tensioner body is mounted to an engine block by bolts (not shown), which extend through holes 20 in metal bushings 19, which are insert-molded into the synthetic resin tensioner body.

In the operation of the tensioner, the high pressure oil chamber 10 is always filled with oil supplied through the reservoir 18, passages 16 and 17, and the check valve 11. The reservoir 18 is hermetically sealed as the hydraulic tensioner 1 is mounted on an engine block. Oil is supplied to the reservoir 18 under pressure, typically by the engine oil pump, which delivers a supply of oil to the reservoir 18 through a port (not shown) in the engine block.

When the timing chain loosens, the plunger 6 is moved in the protruding direction by the compression spring 8. At this time, the check valve 11 is opened, and oil flows through the check valve into the high pressure oil chamber 10. When chain tension is reestablished, the plunger 6 is pushed in the retracting direction, and the check ball is pressed against its seat by oil pressure, so that the check valve 11 is closed.

Since the flat surfaces 4 on the outer circumferential surface of the metal liner 3 are engaged by the material of the tensioner body, the liner cannot rotate relative to the tensioner body. Thus wear due to rotation of the liner is prevented. As a result, increasing oil leaking is avoided, and the generation of abnormal backlash noise, due to insufficient holding force exerted by the tensioner on the chain, can be prevented.

Moreover, since the protrusions 5 are in engagement with overlying parts of the material of the tensioner body, the metal liner 3 is firmly fixed to the inside of the tensioner body 2. Thus, even if the chain exerts a large force pushing the plunger into the liner, the resulting increase in pressure in the high pressure oil chamber 10 will not cause the liner to move in the protruding direction.

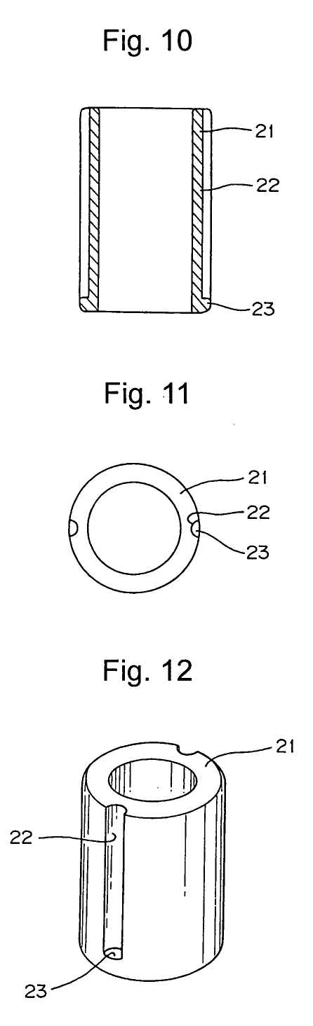

FIGS. 10 to 12 illustrate an alternative embodiment of the invention in which a metal liner 21 is used in place of the liner 3 shown in FIGS. 7-9. As in the first embodiment, the metal liner 21 is insert-molded into the synthetic resin tensioner body.

In the liner 21, concave grooves 22 are provided on the circumferential outer surface of the liner on opposite sides thereof. These grooves extend parallel to the axis of the cylindrical inner wall of the liner. The grooves are preferably formed by cutting or machining, along a part of the length of the liner, in such a way as to leave protrusions 23 at the ends of the grooves, preferably at the ends that will be nearest the bottom of the plunger-receiving hole when the tensioner is assembled. Although the grooves shown in FIGS. 11 and 12 are semicircular, the grooves can have any of various cross-sectional shapes, for example, rectangular.

In the hydraulic tensioner incorporating a grooved liner, the resin material of the tensioner body enters the concave grooves 22 during insert molding. Accordingly, excessive oil leakage resulting from wear due to liner rotation is prevented, and generation of abnormal backlash noise can be avoided.

The protrusions 23 engage ends of the parts of the resin in the grooves, thereby strongly fixing the liner 21 against longitudinal movement in the protruding direction relative to the tensioner body. Thus, the metal liner 21 is prevented from being pushed in the protruding direction by excessive oil pressure in the high pressure oil chamber.

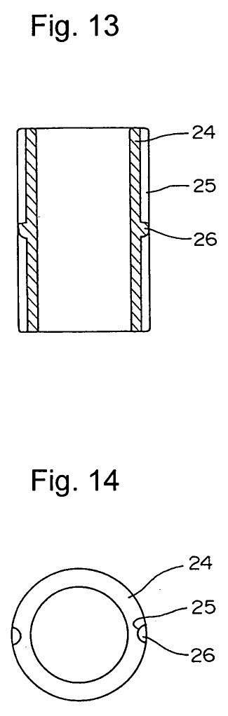

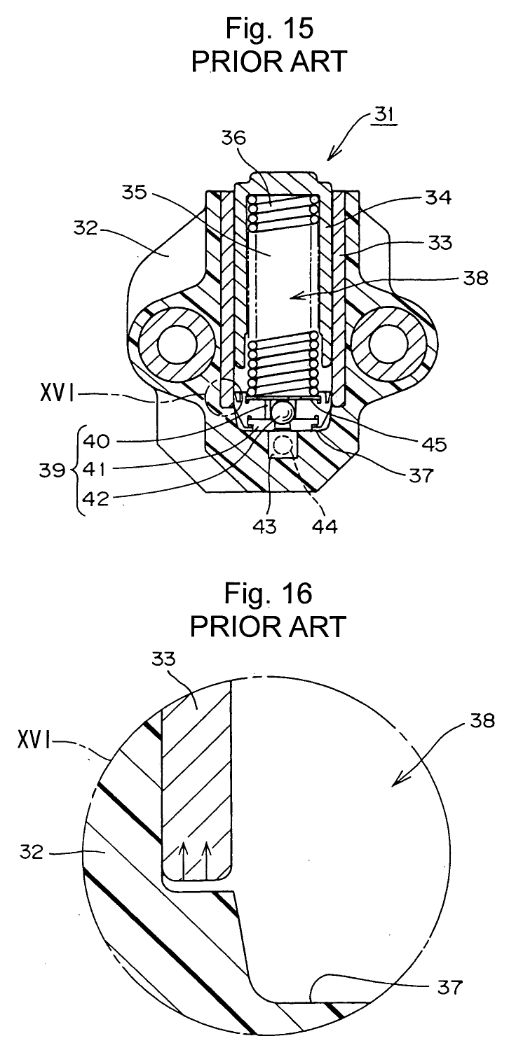

In the third embodiment, shown in FIGS. 13 and 14, a metal liner 24, which can be insert-molded into a synthetic resin tensioner body, has two-part concave grooves 25 on opposite sides of the outer periphery of the liner 24. The concave grooves extend parallel to the axis of the cylindrical inner wall of the liner, and each groove is interrupted by a protrusion 26 located midway between the ends of the liner. Here, as in the case of FIG. 10, the protrusions are easily formed by cutting or machining the liner to form the grooves, while refraining from cutting or machining at the locations at which the protrusions are to be formed.

In the plastic hydraulic tensioner incorporating the metal line of FIGS. 13 and 14, the presence of resin material of the tensioner body in the grooves 25 prevents rotation of the liner, and consequently, wear due to rotation, and resultant increased oil leakage and abnormal backlash noise can be prevented. Furthermore, the engagement of the protrusions 26 with the parts of the resin material within the grooves prevents excessive pressure in the high pressure oil chamber from pushing the liner in the protruding direction.

Variations of the above described tensioners can be adopted. For example, the flat surfaces, the concave grooves, and the protrusions of the liner, instead of being formed by machining or cutting, can be formed by alternative procedures such die casting or forging. The advantages of the invention can be realized in an embodiment in which the metal liner has only one flat surface and only one protrusion, in an embodiment in which the liner has only one concave groove and only one protrusion, or in embodiments in which the metal liner has more than two flat surfaces or concave grooves, and more than two protrusions. Various combinations of flats and protrusions, or grooves and protrusions, and even combinations of flats and grooves in the same liner can also be adopted.

I claim:

1. A hydraulic tensioner comprising:
a tensioner body composed of synthetic resin and having a hollow part formed therein for receiving a hollow cylindrical liner, said hollow part having an opening at one end and having a bottom at an opposite end;
a hollow metal liner having a cylindrical inner wall symmetrical about an axis, an inner end and an outer end, the inner end being closer than the outer end to said bottom of the hollow part of the tensioner body, and an outer peripheral surface, the liner being insert-molded in said hollow part of the tensioner body;
a hollow plunger slidable in the liner, the plunger having an open rear end, and a closed front end protrudable from said liner in a protruding direction;
said hollow part of the plunger, said liner, and the bottom of the hollow part of the tensioner body forming a high pressure oil chamber; and
a compression spring, located in said high pressure oil chamber, and in compression between said closed front end of the hollow plunger and said bottom of the hollow part of the tensioner body, said compression spring urging the hollow plunger in the protruding direction;
in which the hollow metal liner has at least one flat surface or concave groove formed in its outer peripheral surface and disposed in parallel relationship to said axis and a protrusion formed on said flat surface or in said concave groove, the protrusion being engageable with a part of a wall of the hollow part of the tensioner body disposed between the protrusion and said opening to limit movement of the metal liner in a direction from said bottom toward said opening.

2. A plastic hydraulic tensioner according to claim 1, in which said hollow metal liner has at least one flat surface formed in its outer peripheral surface and disposed in parallel relationship to said axis, and in which a part of the wall of said hollow part engages said flat surface and prevents the liner from rotating about said axis relative to said tensioner body.

3. A plastic hydraulic tensioner according to claim 1, in which said protrusion is disposed adjacent said inner end of the hollow metal liner.

4. A plastic hydraulic tensioner according to claim 1, in which said hollow metal liner has at least one concave groove formed in its outer peripheral surface and disposed in parallel relationship to said axis, and in which a part of the wall of said hollow part engages said concave groove and prevents the liner from rotating about said axis relative to said tensioner body.

5. A plastic hydraulic tensioner according to claim 4, in which said protrusion is disposed adjacent said inner end of the hollow metal liner.
